(19) United States
(12) Patent Application Publication
(10) Pub. No.: US 2014/0164376 A1
(43) Pub. Date: Jun. 12, 2014

(54) HIERARCHICAL STRING CLUSTERING ON DIAGNOSTIC LOGS

(71) Applicant: MICROSOFT CORPORATION, Redmond, WA (US)

(72) Inventors: Jinlin Yang, Redmond, WA (US); Jiakang Lu, Redmond, WA (US); Peter Chapman, Bellevue, WA (US)

(73) Assignee: MICROSOFT CORPORATION, Redmond, WA (US)

(21) Appl. No.: 13/707,520

(22) Filed: Dec. 6, 2012

(51) Int. Cl. G06F 17/30

(52) U.S. Cl. CPC G06F 17/3071
USPC 707/737

(57) ABSTRACT

A set of strings can be assigned to clusters utilizing one or more clustering techniques. In accordance with one aspect, hierarchical clustering can be performed in which there are several iterations of clustering. For instance, strings can be clustered based on string length, and each cluster can be assigned to separate sub-clusters based on edit distance between strings. In accordance another aspect, clusters can be analyzed based on the similarity or difference of strings in a cluster to determine if a clustering error exists, and if a clustering error is detected, the cluster can be partitioned into separate clusters.

### BACKGROUND

Debugging computer systems involves a developer analyzing diagnostic logs. A diagnostic log can include numerous textual event messages pertaining to alerts, crash dumps, and exception tracing, for example, which describe the behavior of a computer system. Locating pertinent information to address a problem can be time consuming, because of the sheer quantity of messages comprising a diagnostic log. For instance, in a complex distributed system a diagnostic log can include thousands of messages. Furthermore, messages can look similar, thus making identification of different types of messages difficult.

### SUMMARY

The following presents a simplified summary in order to provide a basic understanding of some aspects of the disclosed subject matter. This summary is not an extensive overview. It is not intended to identify key/critical elements or to delineate the scope of the claimed subject matter. Its sole purpose is to present some concepts in a simplified form as a prelude to the more detailed description that is presented later.

Briefly described, the subject disclosure pertains to string clustering. In accordance with one aspect, the hierarchical clustering can be performed in which there are several iterations of clustering. In other words, there can be multiple levels of string clustering. By way of example, a set of strings can first be clustered based on string length and subsequently each string length cluster can be clustered based on edit distance between strings in the cluster. In accordance with another aspect, clusters can be evaluated for unrelated strings caused by clustering errors. For instance, various conditions can be checked with respect to a cluster signature or longest common subsequence to identify a clustering error. Upon detection of a clustering error, a cluster can be segmented into separate clusters or sub-clusters to correct the error. In accordance with yet another aspect, clusters with the same signature can be identified and combined prior to presenting results to a user

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 is a block diagram of a clustering system.

FIG. 2 is a block diagram of a representative cluster component.

FIG. 3 is a block diagram of a representative adjustment component.

FIG. 4 is a block diagram of an exemplary string clustering workflow.

FIG. 5 is a flow chart diagram of a method of string clustering.

FIG. 6 is a flow chart diagram of a method of hierarchical string clustering.

FIG. 7 is a flow chart diagram of a method of adjusting clusters to correct clustering errors.

FIG. 8 is a schematic block diagram illustrating a suitable operating environment for aspects of the subject disclosure.

### DETAILED DESCRIPTION

Diagnostic logs for computer systems include a large number of messages, especially those pertaining to distributed systems. Further, messages tend to look similar. To mitigate difficulty associated with analyzing a diagnostic log, messages can be grouped. One approach is to use a structured query language (SQL) “GroupBy” operation to group messages based on their unique strings. However, this works poorly on diagnostic logs due to arguments in messages. For example, two messages produced by the same logging function including the same static keywords but different variable arguments would be assigned to different groups.

Details below are generally directed toward automatically grouping messages based on the similarity or difference among messages. In other words, message strings can be clustered. In one instance, hierarchical clustering can be performed in which several iterations of clustering are performed. For example, strings can be clustered first based on length and each of those clusters clustered based on edit distance. In addition, clusters can be analyzed to determine if a clustering error exists such that cluster includes one or more unrelated strings. If a clustering error is detected, the cluster can be partitioned into separate clusters. Subsequently, any clusters that share the same cluster signature can be combined, and the resulting clusters of strings can be presented to user for analysis.

Various aspects of the subject disclosure are now described in more detail with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

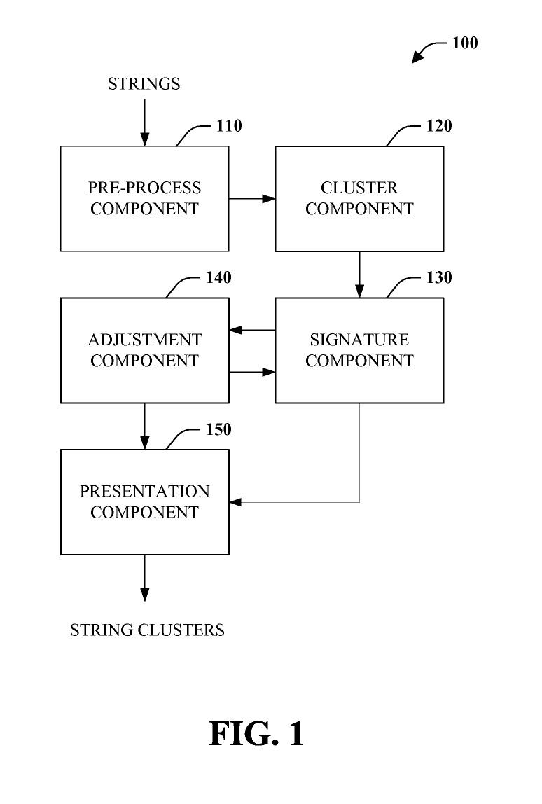

Referring initially to FIG. 1, cluster system 100 is illustrated. The cluster system receives a set of strings as input and outputs a plurality of string clusters or, in other words, clusters of strings. The cluster system 100 can be a stand-alone system or integrated as part of a larger system such as, but not limited to, a monitoring and diagnostic system. The cluster system 100 includes pre-process component 110, cluster component 120, signature component 130, adjustment component 140, and presentation component 150.

The pre-process component 110 is configured to receive, retrieve, or otherwise obtain or acquire strings and perform a degree of processing thereon. A string is a type of data that represents a sequence of elements such as characters, numbers, and spaces. In accordance with one embodiment, the string can correspond to an event message from a diagnostic log, which can be comprised of a sequence of words, among other things. More specifically, a message can be comprised of static keywords and a sequence of argument values generated at runtime. For example, the following can correspond to event messages from a distributed system:
Failed to query the latest MA list; skip updating
Table already exists. tablexyz, ToDelete=False
System.Exception: Direct command did not return successfully at GetTfsWorkitems
Table already exists. tableabc, ToDelete=False
   In the case of event messages, the preprocess component can be configured to filter out duplicate messages such that the resulting output are unique strings. Of course, the subject disclosure is not limited to diagnostic log event messages, and as such, the pre-process component 110 can be configured to perform additional domain specific processing. For instance, if a string is a uniform resource locator (URL), the pre-process component can be configured to segment the URL into words. By way of example, a URL such as “www.xyzabc.com” can produce “www xyz abc com.” Similarly, the pre-process component 110 can also filter out duplicate URLs.

The cluster component 120 receives, retrieves, or otherwise obtains or acquires unique strings produced by the pre-process component and clusters the strings. Stated differently, the cluster component 120 is configured to assign strings to a plurality of clusters. The assignment can be based on similarity of strings to other strings. In accordance with one embodiment, the cluster component 120 can be configured to perform hierarchical clustering in which several iterations of clustering can be performed. For instance, a set of strings can be clustered first as a function of string length and subsequently strings in each string-length based cluster can be clustered based on edit distance.

The signature component 130 is configured to generate a signature for a cluster. A cluster signature identifies common parts that are shared by each string in a cluster. In other words, the signature is the longest common subsequence among strings assigned to a cluster. Consider the following two strings: “Hello World” and “Hello Darling.” Here, the common part and thus the signature is “Hello.” Cluster signatures can be the basis for presenting a group of strings. Rather than presenting all strings in a cluster, a signature can be provided that is representative of the strings in the cluster.

The cluster signature has several beneficial features. First, parameterized portions among clustered event messages can be automatically removed when generating a cluster signature with the longest common subsequence (e.g., largest number of words shared by strings). This allows users to quickly search for relevant information based on common parts among a group of strings. Second, the cluster signature can be utilized to visualize partition quality for each cluster. Usually, a long cluster signature is indicative of higher cluster quality than a short cluster signature. This helps users gain confidence in analysis based on string clustering results. Further, cluster signatures can be utilized as a basis for identifying cluster errors.

The adjustment component 140 is configured to adjust clusters to address detected cluster errors. A cluster error, or mix-up, occurs when a cluster includes unrelated strings. Consider, for example, a first event message that indicates event “XYZ” occurred and a second event message that notes event “ABC” happened. The messages are unrelated and should not be grouped together, but may have been assigned to the same cluster. The adjustment component can detect unrelated strings in a cluster and divide a cluster into separate clusters to resolve the issue. In one embodiment, the adjustment component 140 can employ signatures as a basis for detecting cluster errors. For instance, if a signature length is less than a threshold, a cluster error can be deemed to occur since a lack of common portions can indicate messages are not related. Where, the adjustment component 140 generates new clusters, such clusters can be made available to the signature component 130 to identify a cluster signatures.

The presentation component 150 is configured to present or visualize clusters to a user, such as a developer, on a display, for example. In accordance with one embodiment, the presentation component 150 can analyze cluster signatures and combine clusters that share the same signature prior to presenting results. The final clustering results can be presented to users, by way of a user interface, with the cluster signature in the header and the strings belonging to the cluster in the body. Of course, other presentations are also supported.

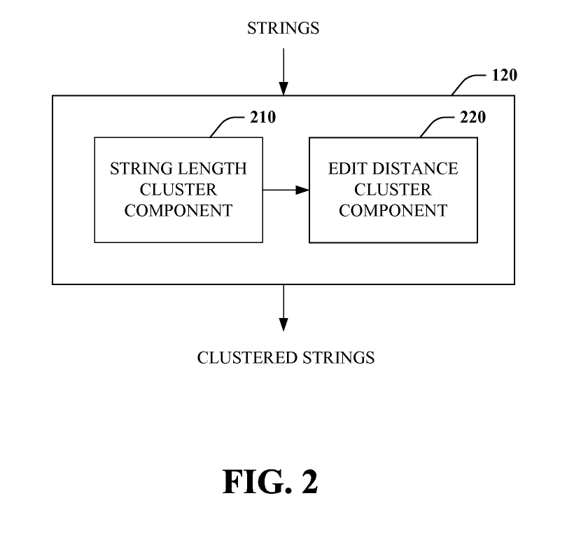

FIG. 2 depicts representative cluster component 120 in further detail. As shown, the cluster component 120 accepts strings as input and outputs clustered strings, and includes string-length cluster component 210 and edit-distance cluster component 220.

The string-length cluster component 210 is configured to assign strings to clusters as a function of string length. The rationale is that similar strings will have similar lengths. Accordingly, two strings with very different lengths are unlikely to be related. Further, string length clustering is computationally cheap and reduces the size of a set of strings on which subsequent clustering can be performed.

Clustering on string lengths can involve three actions. First, unique strings can be located if not performed by a pre-process component. An input dataset is “n” strings “S={s₁, s₂, . . . , sₙ},” and the set of unique strings is “U={u₁, u₂, . . . , uₘ},” where “m” is less than or equal to “n.” The lengths of the unique strings can be calculated, “Len(U)={l₁, l₂, . . . , lₘ}.” Finally, strings can be assigned to clusters based on their length. For instance, k-means clustering can be applied on “Len(U)” and a set of strings can be partitioned into “k” clusters, where “k” is predefined. More specifically, “k” string-length clusters can be denoted as “C_{StrLen={c}₁, c₂, . . . , cₖ}.”

K-means clustering aims to partition “n” strings into “k” clusters where each string belongs to the cluster with the nearest mean. To facilitate understanding of this know clustering technique, suppose there are a set of points in a coordinate system and it is desired to partition the points into two groups. Two points can be selected at random from the set of points and a distance can be calculated. Next, the distance of all other points to the two selected points is computed, and points are assigned to one of the two selected points based on distance, namely the closer of the two selected points. Here, each of the two selected points is the mean, or, in other words, the centroid. After this first round, the centroid can be recomputed based on the associated points. For example, the middle point in the group can be selected. Next, the distance of all points to this new centroid is computed and points assigned thereto. With each additional iteration, the distance decreases. Accordingly, the process can continue to iterate until the distance does not change anymore. With respect to string length clustering, the distance corresponds to difference in string length rather than closeness with respect to a coordinate system.

The edit-distance cluster component 220 can perform edit-distance clustering for strings in each string length cluster, “C_{StrLen}.” Edit-distance clustering is computationally intense. The significant computational overhead associated with computing edit distances is an issue with respect to expeditious clustering. However, clustering on string lengths is computationally cheap and reduces the size of the set of strings on which edit-distance clustering is performed. Edit distance conventionally measures character-level difference between strings. However, experiments show calculating word-level edit distance is much faster than character-level edit distance and still produces acceptable results. Hence, the bottleneck associated with calculating conventional edit distances between strings is utilizing hierarchical clustering and/or word-level edit distances.

In accordance with one embodiment, word-level distance for clustering strings in “C_{StrLen}” can be computed as follows. Assume that “Cᵢ={t₁, t₂, . . . , tₚ}” is one cluster that contains “p” strings. Each string in “tⱼ” is split into a set of words “wⱼ” and the word-level edit distance “d” between two strings is calculated as:

d(t₁,t₂)=|w₁|+|w₂|−2*|LongestCommonSubsequence(t₁,t₂)|

“|LongestCommonSubsequence(t₁, t₂)|” is the number of words in the longest common subsequence between “t₁” and “t₂.” A p-by-p matrix can be generated by calculating the edit distance of each pair of strings:

$$Dist ( {c}_{i} ) = [ \begin{matrix}0 & … & d ( {t}_{1} , {t}_{p } ) \\ ⋮ & ⋱ & ⋮ \\ d ( {t}_{p} , {t}_{1} ) & … & 0\end{matrix} ]$$

Based on the distance matrix, “Dist(cᵢ),” k-means clustering can be applied on “cᵢ,” the cluster can be partitioned into “j” sub-clusters:

cᵢ=sc_{i,1} ∪ sc_{i,2} ∪ . . . ∪ scᵢⱼ, where 1≦j≦p.

Finally, the overall clustering on word-level edit distance includes “v” sub-clusters, “SC_{EditDist}={sc₁, sc₂, . . . , scᵥ}.”

While edit-distance clustering can be executed on a single computer, it can also be distributed across a plurality of computers. For example, a separate computer can be utilized to perform edit-distance clustering for each string-length cluster. Such distributed processing enables much faster clustering.

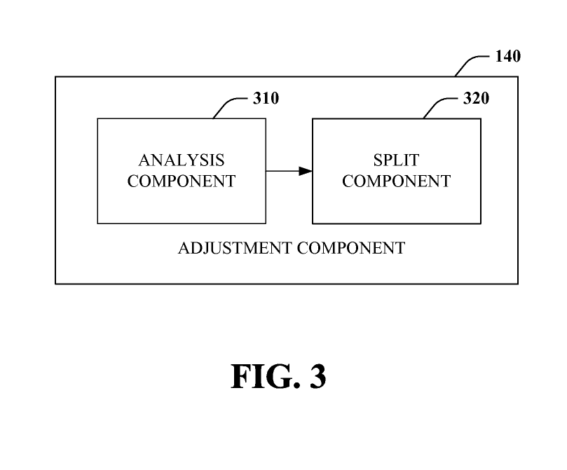

FIG. 3 illustrates a representative adjustment component 140 including analysis component 310 and split component 320. The analysis component 310 is configured to scan and analyze clusters for mixed strings due to clustering errors. For example, the analysis component 310 can utilize cluster signatures identifying a sequence shared by strings in a cluster as a basis for detecting errors. The split component 320 is configured to divide a cluster into separate clusters upon a determination that a cluster error has occurred.

In accordance with one embodiment, a longest common subsequence between a cluster centroid and each string in a cluster can be acquired from the signature component 130 or computed by the analysis component 310. The longest common subsequence is the longest sequence forming part of another sequence whose elements appear in the same order but are not necessarily contiguous. For example, the longest common subsequence between the strings “abcd” and “agbf” is “ab.” A cluster should have a single longest common subsequence among all strings. In some cases, however, it is possible to find multiple unique patterns of longest common subsequence in the same cluster. Consider, for instance, a centroid, a first string, and a second string, namely “abcd,” “ab,” and “cd,” respectively. The longest common subsequence between the centroid and the first string is “ab.” The longest common subsequence between the centroid and the second string is “cd.” Thus, there are two unique longest common sequences, or, in other words, the longest common subsequence is different, and a clustering error is detected. Accordingly, if there is more than one unique pattern of longest common subsequence the analysis component 310 can declare that a clustering error likely occurred. Further, if the length of single pattern of longest common subsequence is less than a threshold, a determination can be made that an error or mix up occurred. For example, the threshold can be less than twenty percent of the length of the cluster centroid. If the common part of a string is less than twenty percent, this means that although they have been grouped together based on distance, the strings are not similar. Hence, the analysis component 310 can check for errors based on whether there is more than one longest common subsequence or the length of a single longest common subsequence is less than or equal to a threshold. If either condition is detected, the split component 320 can be initiated to divide a cluster into separate parts. For instance, if there are two patterns of longest common subsequence in a cluster, the split component can divide the cluster into to clusters each including one or the patterns. The adjusted clustering result is denoted “SC_{Adjusted}={sc₁, sc₂, . . . , sc_{vadjusted},” where “vadjusted” is the total number of clusters after the adjustment.

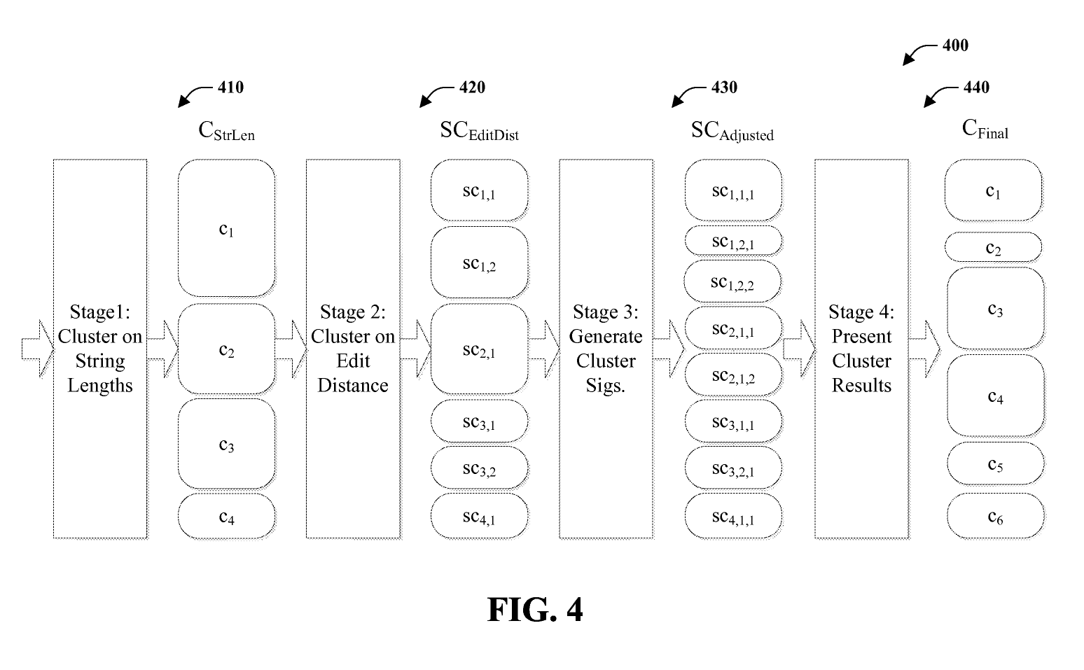

FIG. 4 illustrates an exemplary string clustering workflow 400 in accordance with one embodiment of the invention. The workflow includes four stages. The first stage 410 clusters strings based on string length. As shown, strings can be assigned to four clusters “c₁, c₂, c₃, and c₄.” In the second stage 420, edit distance is employed with respect to strings in each of the four clusters produced by the first stage 410. Here, “c₁” is partitioned into two clusters “sc_{1,1} and sc_{1,2}”, “c₂” remains as one cluster “sc_{2,1}”, “c₃” is divided into two clusters “sc_{3,1} and sc_{3,2},” and “c₄” remains as a single cluster “sc_{4,1}.” The third stage 430 generates signatures for input clusters and partitions clusters if it is determined that a mix up of strings occurred due to a clustering error in either the first stage 410 or the second stage 420. As depicted, “sc_{1,2}” and “sc_{2,1}” are split into two separate groups “sc_{1,2,1}” and “sc_{1,2,2},” and “sc_{2,1,1}” and “sc_{2,1,2},” respectively. The other clusters, “sc_{1,1},” “sc_{3,1},” “sc_{3,2},” and “sc_{4,1}” flow through without partitioning as “sc_{1,1,1},” “sc_{3,1,1}, ” “sc_{3,2,1},” and “sc_{4,1,1}.” The fourth stage 440 takes clusters from the third stage 430 and generates clusters for presentation. As part of this process, clusters with the same signature can be combined into a single group or clusters. Here, “sc_{1,2,2}” and “sc_{2,1,1}” are combined to produce “c₃,” and “sc_{2,1,2}” and “sc_{3,1,1}” are combined as “c₄.” Other clusters flow through without a combining operation. More specifically, _{“sc}_{1,1,1},” “sc_{1,2,1},” sc_{3,2,1},” and “sc_{4,1,1}” become “c₁,” “c₂,” “c₅,” and “c₆,” respectively.

The aforementioned systems, architectures, environments, and the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. Communication between systems, components and/or sub-components can be accomplished in accordance with either a push and/or pull model. The components may also interact with one or more other components not specifically described herein for the sake of brevity, but known by those of skill in the art.

Furthermore, various portions of the disclosed systems above and methods below can include or employ of artificial intelligence, machine learning, or knowledge or rule-based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent. By way of example, and not limitation, the cluster component 120 can employ such mechanisms to adapt results based on user feedback regarding the quality of clustering results.

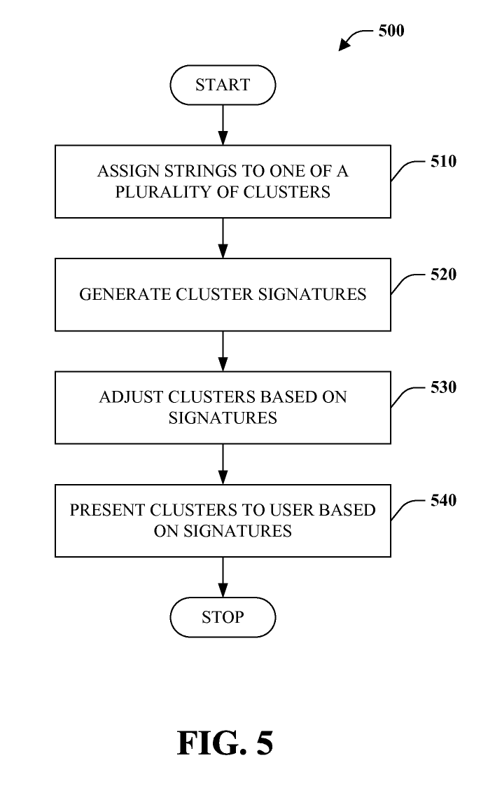

In view of the exemplary systems described supra, methodologies that may be implemented in accordance with the disclosed subject matter will be better appreciated with reference to the flow charts of FIGS. 5-7. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described hereinafter.

Referring to FIG. 5, a method 500 of string clustering is illustrated. At reference numeral 510, a set of strings is assigned to one of a plurality of clusters based on similarity. In accordance with one embodiment, more than one clustering technique can be employed. Further, techniques can be layered hierarchically. Clustering can be based on string length, total number of words, total number of unique words and/or edit distance, among other things. At numeral 520, cluster signatures are generated for each of the plurality of clusters. A cluster signature identifies common parts that are shared by strings in a cluster. At reference 530, zero or more clusters can be adjusted based on cluster signatures. A number of conditions based on cluster signatures or identification thereof can be analyzed to determine whether a cluster error exists. For example, if the length of a signature is less than or equal to a threshold, a cluster error can be deemed to have occurred. The cluster can then be adjusted by segmenting the cluster into two or more separate clusters or sub-clusters. At reference 540, the clusters can be presented to a user based on cluster signatures. In other words, a user will see unique cluster signatures, for instance within a user interface on a physical display. This allows users to quickly search for relevant information based on common parts among a group of strings. Further, the cluster signature visualizes the partition quality of each cluster. For instance, a longer cluster signature represents better quality than a shorter cluster signature.

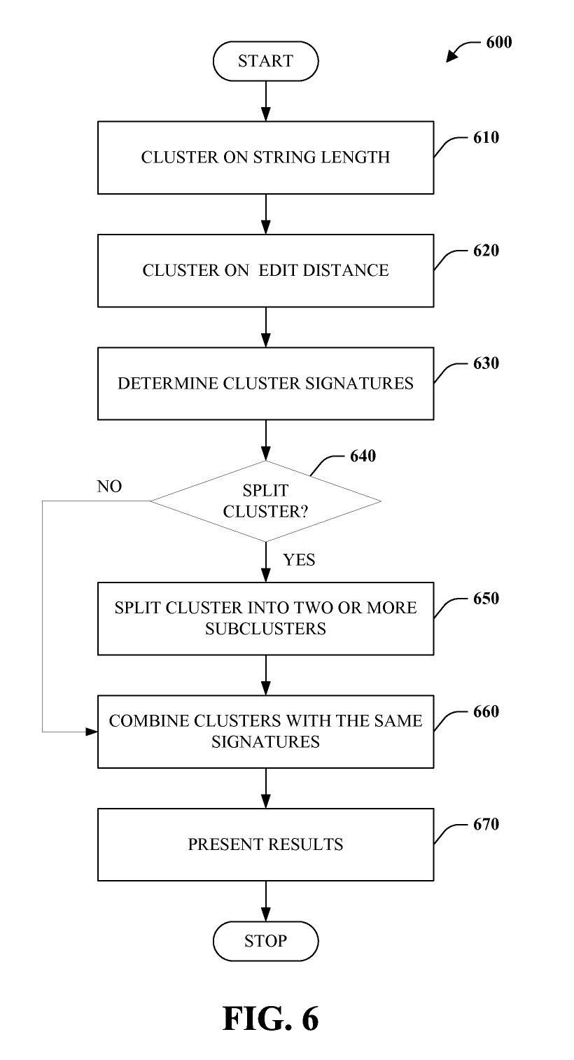

FIG. 6 depicts a method 600 of hierarchical string clustering. At reference numeral 610, a set of strings is clustered on string length. In other words, strings are assigned to a clusters based on similarity as determined based on a comparison of string lengths. At numeral 620, strings within each string length cluster are clustered based on edit distance. Although not limited thereto, in accordance with one embodiment word-level edit distance clustering can be employed. Accordingly, string length clusters can be divided into separate clusters or sub-clusters as a function of an edit-distance for each pair of strings. At numeral 630, a cluster signature is determined for each cluster produced from string-length and edit-distance clustering. A cluster signature can correspond to the longest common subsequence amongst strings in a cluster. At 640, a determination is made as to whether a cluster should be split. The determination can be made based on conditions indicative of clustering errors. For instance, if multiple unique patterns of longest common subsequence exist for the same cluster, it is likely that different types of strings may have been mixed due to clustering errors. As another example, if the length of the longest common subsequence is less than or equal to a threshold, it is likely that strings that are dissimilar were grouped together in a cluster. If it is determined, at 640, that a cluster should be split based on the existence of a predetermined condition (“YES”), the cluster is split into two or more clusters or sub-clusters at numeral 650. Subsequently, the method 600 proceeds to 660. Alternatively, if it is determined that a cluster should not be split (“NO”), for example if no condition is met, the method 600 can continue directly at 660. At numeral 660, clusters with the same signature are combined, since it is possible that during several iterations of clustering and subsequent splitting that clusters can include identical signatures. At reference 670, the clusters and assigned strings are presented or visualized based on cluster signatures.

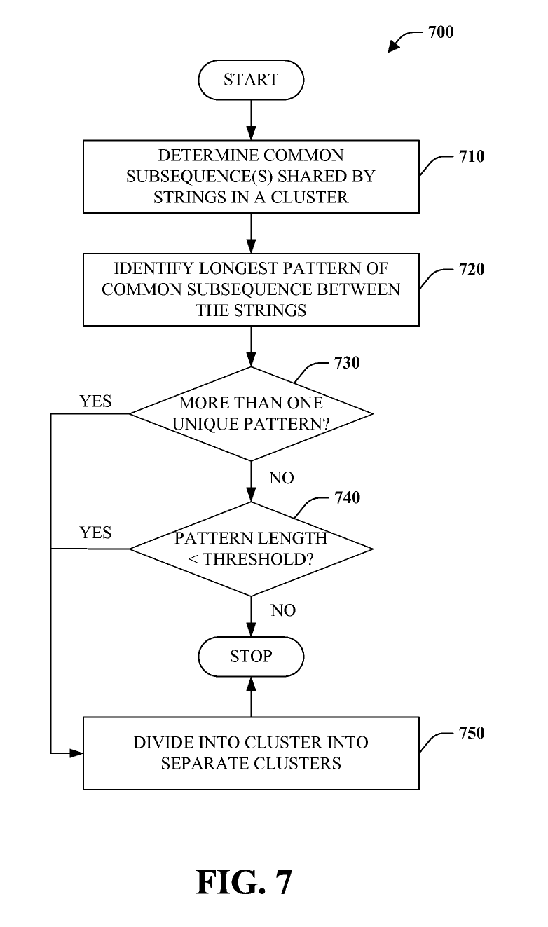

FIG. 7 illustrates a method 700 of adjusting clusters to correct clustering errors. At reference numeral 710, one or more common subsequences shared by strings in a cluster are determined A common subsequence is a sequence that forms part of each string in a cluster where elements of the sequence appear in the same order but are not necessarily contiguous. A longest pattern of common subsequences is identified from the common subsequences shared by strings in a cluster at numeral 720. It is possible a single longest pattern of common sequences may not exist. Rather, multiple unique patterns of the same length may be present. At reference 730, a determination is made as to whether more than one unique pattern of longest common sequence exists. If more than one unique pattern is not present for a cluster (“NO”), the method continues at reference 740, where a determination is made concerning whether the pattern length is less than or equal to a threshold length. If the pattern length is greater than a threshold (“NO”), the method terminates. If, however, there are more than one unique longest common sequence, as determined at 730, or the pattern length is less than or equal to threshold, as determined at 730, the method proceeds to 750. At reference numeral 750, the cluster is divided into multiple separate clusters prior to terminating. The number of strings present in each separate cluster is dependent on a variety of factors including, but not limited to, the number of unique patterns of longest common sequences and the similarity of strings thereto.

The subject invention is not limited to string length and edit distance clustering as described herein, but rather can be employed with respect to any number of different clustering methods or techniques. In accordance with one embodiment, clustering can be based on user provided information or knowledge about strings. For example, a user could inform about a particular type of string for which the user is not interested. Accordingly, those strings can be filtered out and clustering performed on remaining strings. In accordance with another embodiment, clustering can be performed as a function of more than one dimension (e.g., “N” dimensions). For instance, distance can be based on an “N” dimension feature matrix, where “N” is a positive integer greater than or equal to one. As a more concrete example, if a string is provided two different languages, such as English and Spanish, the different languages could be used as an addition dimension. In yet another embodiment, a number of clustering methods can be utilized to compute distances and an average distance computed across the clustering methods employed.

Furthermore, aspects of this disclosure can be utilized with respect to a stand-alone system or integrated within another system as an enabling technology. However, the subject matter is not limited thereto. By way of example, and not limitation, aspects of the subject disclosure can be utilized to implement a fuzzy grouping operation, such as “FuzzyGroupBy.” In other words, rather than grouping identical content as is the convention with a “GroupBy” structured query language operation, “FuzzyGroupBy” can be introduced to group content based on similarity.

The word “exemplary” or various forms thereof are used herein to mean serving as an example, instance, or illustration. Any aspect or design described herein as “exemplary” is not necessarily to be construed as preferred or advantageous over other aspects or designs. Furthermore, examples are provided solely for purposes of clarity and understanding and are not meant to limit or restrict the claimed subject matter or relevant portions of this disclosure in any manner It is to be appreciated a myriad of additional or alternate examples of varying scope could have been presented, but have been omitted for purposes of brevity.

As used herein, the terms “component,” and “system,” as well as various forms thereof (e.g., components, systems, sub-systems . . . ) are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers.

The conjunction “or” as used in this description and appended claims is intended to mean an inclusive “or” rather than an exclusive “or,” unless otherwise specified or clear from context. In other words, “‘X’ or ‘Y’” is intended to mean any inclusive permutations of “X” and “Y.” For example, if “‘A’ employs ‘X,’” “‘A employs ‘Y,’” or “‘A’ employs both ‘X’ and ‘Y,’” then “‘A’ employs ‘X’ or ‘Y’” is satisfied under any of the foregoing instances.

As used herein, the term “inference” or “infer” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the claimed subject matter.

Furthermore, to the extent that the terms “includes,” “contains,” “has,” “having” or variations in form thereof are used in either the detailed description or the claims, such terms are intended to be inclusive in a manner similar to the term “comprising” as “comprising” is interpreted when employed as a transitional word in a claim.

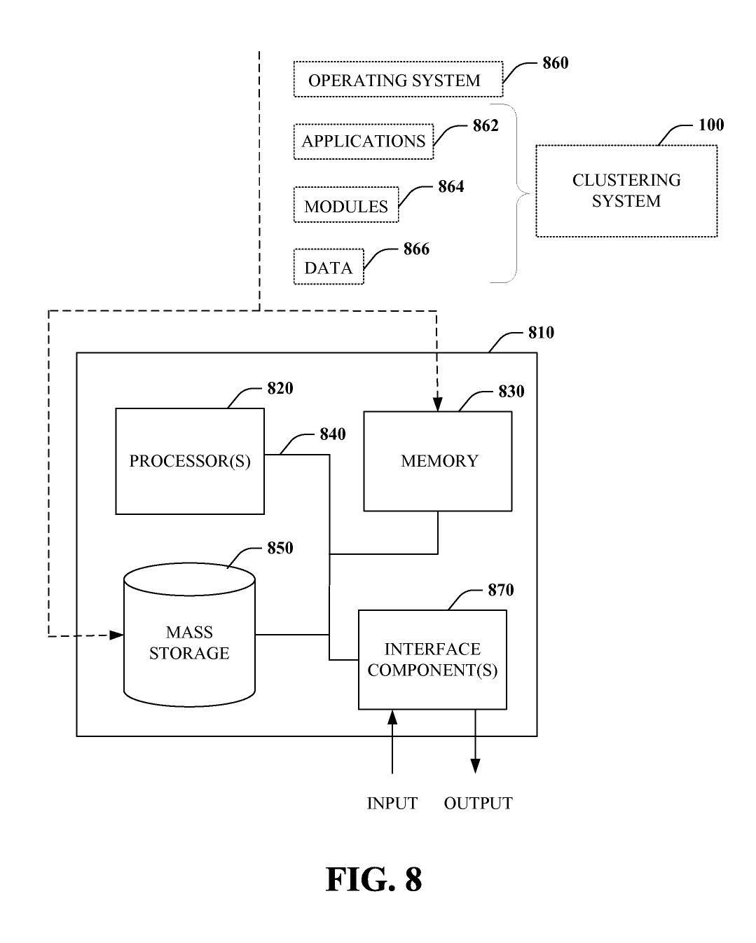

In order to provide a context for the claimed subject matter, FIG. 8 as well as the following discussion are intended to provide a brief, general description of a suitable environment in which various aspects of the subject matter can be implemented. The suitable environment, however, is only an example and is not intended to suggest any limitation as to scope of use or functionality.

While the above disclosed system and methods can be described in the general context of computer-executable instructions of a program that runs on one or more computers, those skilled in the art will recognize that aspects can also be implemented in combination with other program modules or the like. Generally, program modules include routines, programs, components, data structures, among other things that perform particular tasks and/or implement particular abstract data types. Moreover, those skilled in the art will appreciate that the above systems and methods can be practiced with various computer system configurations, including single-processor, multi-processor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. Aspects can also be practiced in distributed computing environments where tasks are performed by remote processing devices that are linked through a communications network. However, some, if not all aspects of the claimed subject matter can be practiced on stand-alone computers. In a distributed computing environment, program modules may be located in one or both of local and remote memory storage devices.

With reference to FIG. 8, illustrated is an example general-purpose computer 810 or computing device (e.g., desktop, laptop, tablet, server, hand-held, programmable consumer or industrial electronics, set-top box, game system, compute node . . . ). The computer 810 includes one or more processor(s) 820, memory 830, system bus 840, mass storage 850, and one or more interface components 870. The system bus 840 communicatively couples at least the above system components. However, it is to be appreciated that in its simplest form the computer 810 can include one or more processors 820 coupled to memory 830 that execute various computer executable actions, instructions, and or components stored in memory 830.

The processor(s) 820 can be implemented with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. The processor(s) 820 may also be implemented as a combination of computing devices, for example a combination of a DSP and a microprocessor, a plurality of microprocessors, multi-core processors, one or more microprocessors in conjunction with a DSP core, or any other such configuration.

The computer 810 can include or otherwise interact with a variety of computer-readable media to facilitate control of the computer 810 to implement one or more aspects of the claimed subject matter. The computer-readable media can be any available media that can be accessed by the computer 810 and includes volatile and nonvolatile media, and removable and non-removable media. Computer-readable media can comprise computer storage media and communication media.

Computer storage media includes volatile and nonvolatile, removable and non-removable media implemented in any method or technology for storage of information such as computer-readable instructions, data structures, program modules, or other data. Computer storage media includes memory devices (e.g., random access memory (RAM), read-only memory (ROM), electrically erasable programmable read-only memory (EEPROM) . . . ), magnetic storage devices (e.g., hard disk, floppy disk, cassettes, tape . . . ), optical disks (e.g., compact disk (CD), digital versatile disk (DVD) . . . ), and solid state devices (e.g., solid state drive (SSD), flash memory drive (e.g., card, stick, key drive . . . ) . . . ), or any other like mediums which can be used to store the desired information and which can be accessed by the computer 810. Furthermore, computer storage media excludes modulated data signals.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 830 and mass storage 850 are examples of computer-readable storage media. Depending on the exact configuration and type of computing device, memory 830 may be volatile (e.g., RAM), non-volatile (e.g., ROM, flash memory . . . ) or some combination of the two. By way of example, the basic input/output system (BIOS), including basic routines to transfer information between elements within the computer 810, such as during start-up, can be stored in nonvolatile memory, while volatile memory can act as external cache memory to facilitate processing by the processor(s) 820, among other things.

Mass storage 850 includes removable/non-removable, volatile/non-volatile computer storage media for storage of large amounts of data relative to the memory 830. For example, mass storage 850 includes, but is not limited to, one or more devices such as a magnetic or optical disk drive, floppy disk drive, flash memory, solid-state drive, or memory stick.

Memory 830 and mass storage 850 can include, or have stored therein, operating system 860, one or more applications 862, one or more program modules 864, and data 866. The operating system 860 acts to control and allocate resources of the computer 810. Applications 862 include one or both of system and application software and can exploit management of resources by the operating system 860 through program modules 864 and data 866 stored in memory 830 and/or mass storage 850 to perform one or more actions. Accordingly, applications 862 can turn a general-purpose computer 810 into a specialized machine in accordance with the logic provided thereby.

All or portions of the claimed subject matter can be implemented using standard programming and/or engineering techniques to produce software, firmware, hardware, or any combination thereof to control a computer to realize the disclosed functionality. By way of example and not limitation, the clustering system 100, or portions thereof, can be, or form part, of an application 862, and include one or more modules 864 and data 866 stored in memory and/or mass storage 850 whose functionality can be realized when executed by one or more processor(s) 820.

In accordance with one particular embodiment, the processor(s) 820 can correspond to a system on a chip (SOC) or like architecture including, or in other words integrating, both hardware and software on a single integrated circuit substrate. Here, the processor(s) 820 can include one or more processors as well as memory at least similar to processor(s) 820 and memory 830, among other things. Conventional processors include a minimal amount of hardware and software and rely extensively on external hardware and software. By contrast, an SOC implementation of processor is more powerful, as it embeds hardware and software therein that enable particular functionality with minimal or no reliance on external hardware and software. For example, the clustering system 100 and/or associated functionality can be embedded within hardware in a SOC architecture.

The computer 810 also includes one or more interface components 870 that are communicatively coupled to the system bus 840 and facilitate interaction with the computer 810. By way of example, the interface component 870 can be a port (e.g., serial, parallel, PCMCIA, USB, FireWire . . . ) or an interface card (e.g., sound, video . . . ) or the like. In one example implementation, the interface component 870 can be embodied as a user input/output interface to enable a user to enter commands and information into the computer 810, for instance by way of one or more gestures or voice input, through one or more input devices (e.g., pointing device such as a mouse, trackball, stylus, touch pad, keyboard, microphone, joystick, game pad, satellite dish, scanner, camera, other computer . . . ). In another example implementation, the interface component 870 can be embodied as an output peripheral interface to supply output to displays (e.g., CRT, LCD, plasma . . . ), speakers, printers, and/or other computers, among other things. Still further yet, the interface component 870 can be embodied as a network interface to enable communication with other computing devices (not shown), such as over a wired or wireless communications link.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims.

What is claimed is:

1. A computer-implemented method, comprising:
identifying one or more longest common subsequences amongst a set of strings in a cluster; and
assigning strings with a different longest common subsequence to separate clusters.

2. The method of claim 1 further comprises assigning a string to a separate cluster, if length of a longest common subsequence is less than a threshold.

3. The method of claim 1 further comprises generating the cluster as a function of edit distance between strings.

4. The method of claim 3, generating the cluster as a function of a word-level edit distance between strings.

5. The method of claim 3 further comprises generating the cluster as a function of string length.

6. The method of claim 1 further comprises:
determining a centroid for the set of strings in a cluster; and
identifying the one or more longest common subsequences between the centroid and each string in the set of strings.

7. The method of claim 1 further comprises combining clusters with identical longest common subsequences.

8. The method of claim 7 further comprises presenting the clusters to a user.

9. A clustering system, comprising:
a processor coupled to a memory, the processor configured to execute the following computer-executable components stored in the memory:
a first component configured to assign a set of strings to one or more clusters; and
a second component configured to detect one or more cluster errors as a function of strings assigned to a cluster.

10. The system of claim 9, the first component is configured to assign the set of strings to the one or more clusters based on edit distance between strings.

11. The system of claim 10, the first component is configured to assign the set of strings to the one or more clusters based on string length.

12. The system of claim 9, the second component is configured to detect the one or more cluster errors based on a length of a longest common subsequence among the strings.

13. The system of claim 9 further comprises a third component configured to divide the cluster into separate clusters, if a cluster error is detected.

14. The system of claim 9 further comprises a third component configured to present the one or more clusters to a user.

15. The system of claim 9, the set of strings comprises a plurality of distributed-system diagnostic messages.

16. A computer-readable storage medium having instructions stored thereon that enable at least one processor to perform a method upon execution of the instructions, the method comprising:
assigning a set of unique strings to a set of clusters based on string length;
partitioning strings from a cluster of the set of clusters into one or more sub-clusters as a function of edit distance between strings;
splitting a sub-cluster into separate sub-clusters based on common parts shared by strings in the sub-cluster; and
presenting the sub-clusters to a user.

17. The method of claim 16 further comprises combining sub-clusters that share common parts prior to presenting the sub-clusters to the user.

18. The method of claim 16, partitioning strings from the cluster as a function of a word-level edit distance between strings.

19. The method of claim 16 further comprises identifying the set of unique strings from an input set of strings.

20. The method of claim 16, assigning a set of unique diagnostic message strings to the set of clusters based on string length.
